(19) United States
(12) Patent Application Publication
(10) Pub. No.: US 2005/0244569 A1
(43) Pub. Date: Nov. 3, 2005

(54) Automatic tolerance determination system for material application inspection operation

(75) Inventors: Peter W. Estelle, Norcross, GA (US); Scott B. Means, Lawrenceville, GA (US)

Correspondence Address: WOOD, HERRON & EVANS, LLP (NORDSON), 2700 CAREW TOWER, 441 VINE STREET, CINCINNATI, OH, 45202, US

(73) Assignee: Nordson Corporation

(21) Appl. No.: 11/115,745

(22) Filed: Apr. 27, 2005

Related U.S. Application Data
(60) Provisional application No. 60/566,287, filed on Apr. 29, 2004.

(51) Int. Cl. B05D 1/00

(52) U.S. Cl. 427/8

(57) ABSTRACT

A method, apparatus and program product automatically determine and set a tolerance window to verify and monitor the accuracy of an adhesive application. Statistical data is processed concurrently to determine the tolerance at a given inspection point. The system then applies adhesive per application specifications and monitors the product result based on the new statistical tolerances, which may be fed back in real time to track system hardware and adhesive pattern variances.

### RELATED APPLICATIONS

This application claims the benefit of U.S. Provisional Application No. 60/566,287 filed on Apr. 29, 2004, the entire disclosure of which is hereby incorporated by reference herein.

### FIELD OF THE INVENTION

The present invention relates generally to fluid dispensing systems for dispensing flowable material, such as adhesives, sealants, caulks and the like, onto a substrate, and more particularly, to a system and method for monitoring the operation of such systems.

### BACKGROUND OF THE INVENTION

The ability to precisely dispense a fluid, for example, an adhesive, is a necessity for manufacturers engaged in the packaging and plastics industries. A typical fluid dispensing operation employs a dispensing gun to apply the adhesive onto a substrate being moved past the dispensing gun, for example, by a conveyor. The speed of the conveyor, or line speed, is set according to such factors as the complexity of the dispensing pattern and the configuration of the gun. Adhesive is normally supplied to the dispensing gun under pressure by a piston or motor driven pump.

The quality of the adhesive dispensing process is subject to many variables that include general environmental conditions, the physical state of the adhesive being dispensed, the physical condition of the dispensing apparatus and the stability of electrical and other system parameters. Changes in those variables often result in changes in the actuation time of the dispensing gun. For example, if an electric dispensing gun is being used with an unregulated power source, fluctuations in line voltage alter the actuation time of the dispensing valve, that is, the time required to open and close the dispensing gun. An increase in line voltage results in the actuating time decreasing. As a result, the dispensing gun opens faster, which causes the adhesive to flow through the gun sooner than expected. Thus, the adhesive is deposited onto the substrate at a different location than anticipated. The gun may consequently open so fast that the fluid is dispensed prior to the substrate reaching a desired position. Thus, adhesive is dispensed at a location not intended to receive adhesive. A similar problem occurs if the dispensing gun experiences a drop in line voltage.

Variations in gun actuation times are also caused by changes in the viscosity of the adhesive being dispensed. Heaters within the fluid dispensing system can malfunction, or heat can be transferred into, and retained by, the fluid dispensing gun in its normal operation. Either of those conditions can change the temperature of the adhesive, thereby changing its viscosity. Viscosity variations change the drag of the adhesive on the dispensing gun's armature and hence, the actuation times of the dispensing valve and the flow rate of the adhesive. As previously discussed, changes in the actuation time may result in the application of adhesive at undesirable locations on the substrate. Similarly, changes in the flow rate can adversely affect the location of the adhesive on the substrate.

Variations in the operation of the dispensing gun also occur for other reasons. The mechanical wear and aging of components within the dispensing gun can impact gun actuation time. For example, a return spring is often used to move the dispensing valve in opposition to a solenoid. Over its life, the spring constant of the return spring changes, thereby changing the rate at which the dispensing valve opens and closes, and hence, the location of dispensed adhesive on a substrate. Further, the accumulation of charred adhesive within the dispensing gun over its life often increases frictional forces on the dispensing valve, thereby changing gun actuation time.

Thus, for the above and other reasons, the operation of the dispensing gun is subject to many changing physical forces and environmental conditions that cause variations in the actuation time of the dispensing gun. Such dispensing gun variations in opening and closing actuation times produce variations from desired locations of adhesive that are deposited onto a substrate.

The “SEAL SENTRY” and “G-NET” systems, which are commercially available from Nordson Corporation of Duluth, Ga., generally verify the quality of the adhesive dispensing process by sensing bead edges within a programmed window. By monitoring the sensed occurrences of adhesive bead edges within respective programmed tolerances of occurrences, the system detects bead presence and hence, provides an indicator of the quality of the adhesive dispensing process.

This verification system requires that the adhesive pattern that is programmed into the pattern controller also be programmed into the monitoring system. Thus, the system requires a highly skilled technical operator for a substantial period of time to perform the programming. Further, if the adhesive dispensing process experiences drift or changing pattern requirements, it is easy to overlook the necessity of also changing the corresponding adhesive pattern in the monitoring system. That is, even after a tolerance has been established, ongoing changes within the system may relatively quickly render the last tolerance calculation obsolete.

More particularly, prior applications require operators to manually calculate and enter tolerances into the system. Such calculations rely on numbers taken from operator judgment and/or a manual or other reference that reflects an estimated condition. As discussed herein, however, actual gun conditions can deviate substantially from those of estimates. Even where an operator has the benefit of knowing bead measurements on a running line, the operator is still relegated to making manual calculations of the tolerance based on estimates and past experience. Even a slight variation attributable to such subjective calculations can result in wasted product.

Manually set tolerances of the prior art are static in the sense that verification tolerances do not change in accordance with pattern changes or equipment capabilities. That is, the tolerance remains the same irrespective of actual conditions and job requirements. Consequently, rejected products result until a verification template is manually changed to match a new pattern or other condition. This condition can become exacerbated during the beginning and ending periods of gluing application, when conveyor speeds can dramatically vary.

In view of the foregoing, it is incumbent upon the operator to make necessary changes to the control pattern according to the results of a verification process. Even where the operator can do so in a relatively timely fashion, any delay can result in a period of imprecise adhesive application and wasted product. Thus, the programming and maintenance of conventional verification systems can be relatively complex, inefficient and labor intensive. Such conventional systems may also prove insufficiently robust with regard to false rejects. That is, systems routinely mistake good samples for bad, causing good product to be rejected.

Therefore, there is a need for a verification system that effectively and reliably detects the quality of the dispensing process and is relatively easy for the user to setup, use and maintain.

### SUMMARY OF THE INVENTION

The above stated problems of the prior art are addressed by an improved verification system that automatically determines and sets a tolerance to verify and monitor the accuracy of an adhesive application. The tolerance includes a range of acceptable data measurements for a given inspection point along the surface of a substrate. Statistical data may be processed concurrently to automatically determine a respective tolerance at each applicable inspection point. Adhesive is applied per application specifications and the product result may be monitored based on the new tolerances, which may be fed back in real time to track system hardware and adhesive pattern variances. Product samples are accepted or rejected based upon whether a data measurement falls within the automatically determined tolerance.

A wide array of statistical measurements may be used to accurately and automatically determine the tolerance as part of a quality control process. For instance, the system may determine a standard deviation and mean, as well as generate Gaussian or other distribution curves. Where the automatically determined mean or other reference location deviates from a target position by an unacceptable amount defined by a distribution limit, the target position of a bead or other adhesive pattern may be automatically shifted or otherwise adjusted.

The verification system of the present invention is easy to use, as well as easier to setup and maintain. The tolerance feedback feature of the present invention is especially useful in addressing those adhesive dispensing applications challenges that relate to changing application and equipment conditions. Therefore, the system increases yields and reduces scrap product and hence, reduces manufacturing costs and product unit cost.

Features of the present invention that automatically determine edge tolerance greatly reduce the complexity and inaccuracies associated with manually calculating the tolerances. Such tolerances are conventionally determined by trial and error, resulting in wasted product and time. Features of the invention also enhance robustness and reduce the number of false detections by virtue of their statistical foundation.

In one embodiment, tolerances may be automatically determined with or without a mechanism for feeding back tolerance information through pattern control. Such an application may be useful where a system is generally only concerned with monitoring, not correction. When combined with a feedback control mechanism, however, changes in the determined tolerance will track ongoing and actual pattern changes.

In terms of adhesive monitoring, features of the invention may track any pattern type, which may range from a single bead to any number of beads and bead configurations. Still other adhesive patterns verified by the processes of the present invention may include swirl patterns, other back and forth patterns, dots, film, atomized or sprayed applications, etc. Feedback features may further accommodate changes in variable line speed and other operating variables. Thus, the integration of verification and dispensing functions of the present invention improve efficiency, speed and accuracy. The system also requires less setup time than with conventional systems that require the tedious and continuous input of manually calculated tolerances.

In one respect, the system learns new tolerance limits after a change is made to a pattern. Namely, the system may automatically and concurrently learn a new pattern or other variation by conducting statistical analysis on sample data that embodies the change. The system thus accommodates various adhesive pattern types such as those produced by autospotting, which can change on-the-fly. Where an operator changes an adhesive pattern, e.g., changes the position of a leading bead edge from ten to twenty millimeters, the same statistics and/or previous tolerance determinations relating to the equipment may be reused, where applicable. Thus, the system avoids confusion, interruption and other efficiencies conventionally associated with adhesive pattern changes.

In one sense, the system functions in a learning mode where statistical data is monitored as products go by on the conveyer. In so doing, the system essentially determines a tolerance that defines what a good products is, i.e., the system learns the nature of an expected pattern. In automatically performing a statistical analysis of the data measurements, the system assesses the consistency, capability and precision of a dispensing system. The system may then compute recommended tolerances according to where the edge points of a pattern ought to be.

A respective standard deviation may be determined for each edge or other inspection point. This feature accommodates system irregularities such as pressure drops, jitter due to the mechanical conveyer, environmental electrical noise, accumulator or momentum effects, etc. The system thus accounts for normal variations inherent in a system while flagging abnormal variation.

Embodiments consistent with the principles of the present invention have particular application when a conveyer changes speeds. That is, real time feedback mechanisms of the invention are particularly useful during stops and starts, when speed fluctuates greatly. In tracking the speed changes via the feedback loop, considerably less substrate is wasted than with conventional systems.

Various additional advantages, objects and features of the invention will become more readily apparent to those of ordinary skill in the art upon consideration of the following detailed description of embodiments taken in conjunction with the accompanying drawings.

### BRIEF DESCRIPTION OF THE DRAWINGS

The accompanying drawings, which are incorporated in and constitute a part of this specification, illustrate embodiments of the invention and, together with a general description of the invention given above, and the detailed description of the embodiments given below, serve to explain the principles of the invention.

FIG. 1 is a schematic block diagram of a fluid dispensing system in accordance with the principles of the invention.

FIG. 2 is a flowchart having an exemplary sequence of steps executable by the dispensing system of FIG. 1.

FIG. 3 is a flowchart having a series of exemplary steps that are executable by the system controller of FIG. 1 for automatically determining the tolerance used in the processes of FIG. 2.

FIG. 4 shows a table having product sample data creating using the tolerance determination and verification processes of FIGS. 1 and 2.

FIG. 5 shows an exemplary distribution histogram displayed by the display of the system of FIG. 1.

### DETAILED DESCRIPTION OF THE INVENTION

The various embodiments of the verification system of the present invention automatically determine and set a tolerance window to verify and monitor the accuracy of an adhesive application. The system typically analyzes statistical data to automatically determine respective tolerances at a number of inspection points. In one respect, the system may effectively “learn” a pattern from the data measurements and then compute respective reference locations, such as means, in addition to respective spreads, such as standard deviations, and ultimately, tolerances based on the learned pattern. The system then applies adhesive per application specifications and monitors the product result based on the new statistical tolerances. These tolerances are thus fed back in real time to track system hardware and adhesive pattern variances.

In one example, samples are gathered and a standard deviation or other spread is automatically computed. Other exemplary spreads may include an interquartile range or a distance. Continuing with the above example, the automatically determined standard deviation may be adjusted by a tolerance factor “k” before being applied to a next arriving substrate as a new tolerance. By applying statistical methods, the system accommodates inherent and external variations in the application processes.

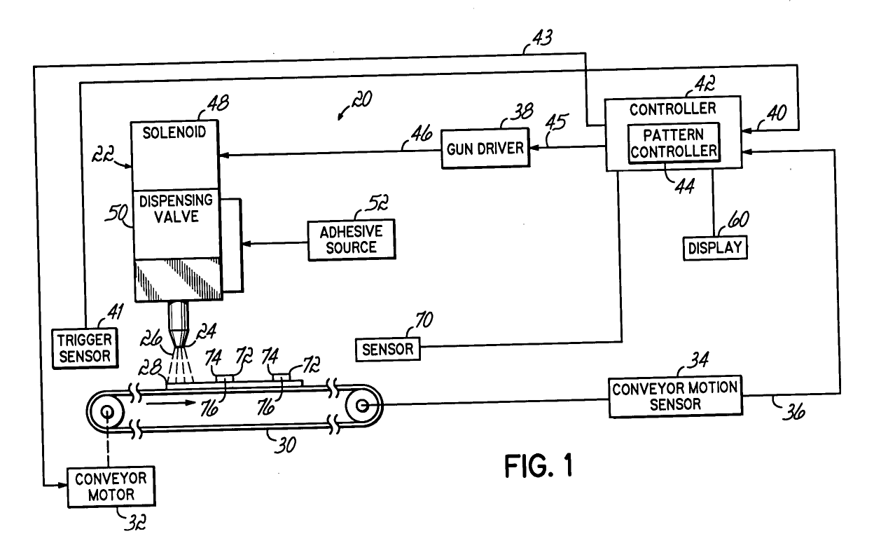

Referring to FIG. 1, a fluid dispensing system 20 is comprised of a fluid dispensing gun 22 having a nozzle 24 for dispensing a fluid 26, for example, an adhesive, onto a substrate 28. The substrate 28 is carried by a conveyor 30 past the dispensing gun 22. The conveyor 30 is mechanically coupled to a conveyor drive having a conveyor motor 32. Motion of the conveyor is detected by a conveyor motion sensor 34, for example, an encoder, resolver, etc. The motion sensor 34 has an output 36 providing a feedback signal that changes as a function of changes in the conveyor position.

A system controller 42 generally functions to coordinate the operation of the overall fluid dispensing system 20. A typical controller includes a central processing unit (CPU). Such a CPU may comprise part of or otherwise be in communication with a desktop or laptop computer in communication with the gun driver 38. As such, the system controller 42 normally includes a keyboard or other user interface for the system 20 and controls the operation of the conveyor motor 32 via a line signal 43.

The system controller 42 typically executes a pattern control program 44 to control the operation of the fluid dispensing gun 22 as a function of a particular application. The controller 42 receives as an input 40, a trigger signal from a trigger sensor 41. The trigger sensor 41 detects a feature or characteristic, for example, a leading edge of the substrate 28. The trigger signal provides synchronization with regard to the motion of the substrate 28 on the moving conveyor 30.

In response to the trigger signal, the controller 42 provides a sequence of transition signals, that is, gun ON/OFF signals, normally in the form of pulses to a gun controller or driver 38 via an input 45. In the described embodiment, each of the gun ON/OFF signals has leading and trailing edges representing desired changes in state of the operation of the dispensing gun 22. The leading edges initiate a gun ON or open operation, and the trailing edges initiate a gun OFF or close operation. Thus, the leading and trailing edges of the gun ON/OFF signal from the controller 42 are transition signals representing transitions of the operating state of the dispensing gun.

The gun driver 38 provides command signals on an output 46 to operate the dispensing gun 22 as a function of the timing and duration of the gun ON/OFF pulses from the controller 42. In response to a leading edge of a gun ON/OFF signal, the gun driver 38 provides a gun command that operates a solenoid 48. In a known manner, the solenoid 48 is mechanically coupled to a dispensing valve 50 that is fluidly connected to a pressurized source of adhesive 52.

Upon receiving a command signal from the gun driver 38, the solenoid 48 opens the dispensing valve 50. Pressurized adhesive in the dispensing gun 22 passes through the nozzle 24 and is deposited onto the substrate 28 as a bead 76. The dispensing valve 50 remains open for the duration of the gun ON/OFF pulse. In response to the trailing edge of a gun ON/OFF pulse, the gun driver 38 provides a command signal changing the state of the solenoid 48 to close the dispensing valve 50. In most applications, as the substrate 28 is moved past the dispensing gun 22, a plurality of gun ON/OFF pulses causes the gun driver 38 to rapidly open and close the dispensing valve 50 to deposit a plurality of beads, dots or spots of adhesive 76 at different locations on the substrate 28.

The fluid dispensing system 20 further includes a display 60. A typical display may include a computer monitor in communication with the controller 42, but other displays may include a liquid crystal display, light emitting diodes, etc. Where desired, a graphical distribution may be displayed in the form of a histogram or other appropriate graph or depiction. For example, the display may include a chart or graph showing information regarding the statistical samples and recommended tolerances. Statistical information is typically displayed using a format selected from a group consisting of at least one of: a chart, a graph, a table, an image indicative of the data measurement relative to another data measurement, an image indicative of the data measurement relative to the tolerance and an image indicative of the data measurement relative to the substrate surface.

The sensor 70 may be mounted with respect to the conveyor 30 such that the sensor 70 can detect leading and trailing edges 72, 74, respectively, of the adhesive beads 76 as the substrate moves on the conveyor 30. The sensor 70 may include any sensor capable of reliably detecting a product characteristic at an inspection point. Exemplary characteristics may comprise the leading and trailing edges of a bead 72, 74, respectively, as well as adhesive volume, height, width and pattern configuration considerations, where applicable. Other characteristics may include a substrate feature, such as where a cellophane cutout begins and ends on the substrate 28. For example, a sensor 70 may be an infrared sensor, laser sensor, volume sensor, cellophane sensor, photocell proximity sensor, optical camera, etc. An inspection point includes an area or space where a product characteristic is to be sampled.

In general, the routines executed by the controller 42 to implement the embodiments of the invention, whether implemented as part of an operating system or a specific application, component, program, object, module or sequence of instructions, or even a subset thereof, will be referred to herein as “program code.” Program code typically comprises one or more instructions that are resident at various times in various memory and storage devices in a controller, and that, when read and executed by one or more processors in a controller, cause that controller to perform the steps necessary to execute steps or elements embodying the various aspects of the invention.

Moreover, while the invention has and hereinafter will be described in the context of fully functioning computers and other controllers, those skilled in the art will appreciate that the various embodiments of the invention are capable of being distributed as a program product in a variety of forms, and that the invention applies equally regardless of the particular type of computer readable signal bearing media used to actually carry out the distribution. Examples of computer readable signal bearing media include but are not limited to recordable type media such as volatile and non-volatile memory devices, floppy and other removable disks, hard disk drives, magnetic tape, optical disks (e.g., CD-ROMs, DVDs, etc.), among others, and transmission type media such as digital and analog communication links.

In addition, various program code described hereinafter may be identified based upon the application within which it is implemented in a specific embodiment of the invention. However, it should be appreciated that any particular program nomenclature that follows is used merely for convenience, and thus the invention should not be limited to use solely in any specific application identified and/or implied by such nomenclature.

Furthermore, given the typically endless number of manners in which computer programs may be organized into routines, procedures, methods, modules, objects, and the like, as well as the various manners in which program functionality may be allocated among various software layers that are resident within a typical computer (e.g., operating systems, libraries, applications, applets, etc.), it should be appreciated that the invention is not limited to the specific organization and allocation of program functionality described herein. Those skilled in the art will recognize that the exemplary environment illustrated in FIG. 1 is not intended to limit the present invention. Indeed, those skilled in the art will recognize that other alternative hardware and/or software environments may be used without departing from the scope of the invention.

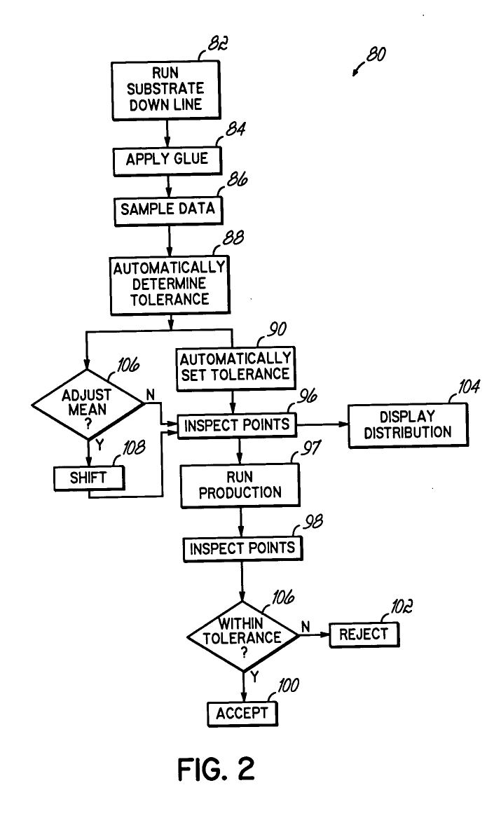

FIG. 2 is a flowchart 80 having an exemplary sequence of steps executable by the dispensing system 20 of FIG. 1 for automatically verifying product and adjusting for changing application conditions. At block 82 of FIG. 2, the substrate 28 is moved by the conveyer 30 towards the dispensing gun 50. Adhesive 76 is applied at block 84 by the gun 50 according to a preset pattern. The pattern is typically programmed in the controller 42 according to a manufacturer's specifications prior to or during an adhesive operation. Such patterns may include different product characteristics, such as bead length, placement and pattern as is know in the art.

The sensor 70 of the system 20 may sample inspection points at block 86 of FIG. 2. The inspection points are used to test the accuracy of the adhesive placement, for instance. As such, inspection points are typically predetermined according to the sample pattern to include critical positions or other characteristics indicative of the effectiveness of an application. For instance, inspection points may include locations expected to coincide with adhesive edges and transition points, as well as with substrate edges and cutouts. Adhesive characteristics measured at block 86 may include length and volume measurements, among others. One skilled in the art will thus appreciate that any number of additional characteristics may be alternatively and/or concurrently sampled at block 86.

In any case, one or more sensors are positioned to sample data indicative of a product characteristic at the relative position of an inspection point. The processes of block 86 of FIG. 2 may presuppose that a number of samples to be accomplished has been preset. For instance, a system 20 may accomplish a predetermined number of fifteen data measurements on fifteen substrate products for each inspection point at block 86. One skilled in the art will appreciate that any number of samples sufficient to generate a meaningful statistical result may be taken in accordance with the underlying principles of the present invention.

The system 20 uses these data samples to automatically determine a tolerance at block 88. The tolerance may include a window of acceptable readings within which data sampled at an inspection point must fall for a product application to be considered acceptable. By virtue of using actual data samples, the system controller 42 determines a tolerance that accounts for all system conditions, including gun and conveyer capabilities, as well as substrate and other actual application conditions, for instance. Namely, the actual measurements are produced using whatever machinery and conditions caused variance in the adhesive placement. Consequently, the determined tolerance will have the equipment and condition variance already factored in. The automatic determination of the tolerance further alleviates operators from manual calculations that are prone to inefficiency and inaccuracy.

The tolerance window determined at block 88 may be set or otherwise implemented by the controller 42 at block 90 of FIG. 2. The tolerance is set for each inspection point according to the product/adhesive position or other characteristic. Automatically setting the tolerance at block 90 thus provides real time feedback using the actual sample data. Such a feature is particularly beneficial during application starts and stops, when conveyor speeds vary dramatically. Such speed variation causes wasted product in conventional systems, which cannot adapt in real time to the different rates at which the substrate arrives during these periods. While other advantages are realized by virtue of a real time feedback implementation as shown in FIG. 2, one skilled in the art will appreciate that another embodiment may simply output the determined tolerance at block 88 without feeding back the data to adjust the tolerance.

In one preferred embodiment that is consistent with the principles of the present invention, the system 20 may continuously run production and sample data at blocks 97 and 98, respectively. These processes may constantly monitor system performance using the set of tolerances determined at block 90. An automatically determined and set tolerance may thus be continuously referenced when inspecting data points at block 96. Where a data point is within the determined tolerance at block 98, the substrate sample is accepted at block 100. Where the inspected point falls outside of the determined tolerance window at block 98, the product is typically rejected at block 102. Such rejection processes may include marking the substrate, initiating an alarm or other notification, as well as automatically identifying and discarding the substrate using a known ejection mechanism.

As discussed in greater detail below, a visual representation of an inspection point distribution and tolerance windows may be displayed to a user at block 104. Such a display may further communicate additional data to a user that can be used to better inform and hone the adhesive application process.

As shown at block 106 of FIG. 2, the controller 42 may additionally determine whether a preprogrammed adhesive point of adhesive application should be shifted at block 108 based on the tolerance and/or a mean determination of block 88. Such may be the case where the sample data reveals that a majority of adhesive samples are consistently placed off target, as determined from the mean, or average. One skilled in the art will appreciate that while a mean may have particular application within one embodiment of the present invention, other reference locations, such as a median, mode, etc. may be equally applicable in another embodiment.

The shift process at block 108 may automatically reset the target, programmed point of application at the controller 42 as necessary to compensate for the average distance off target. After the outlier samples have been discarded, the standard deviation may be recomputed using the remaining good data. This automatic adjustment further provides another feature for improving efficiency and accuracy without requiring direct operator intervention.

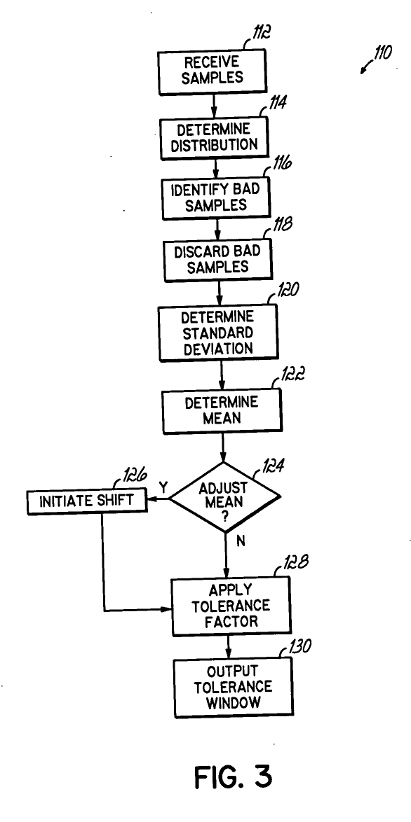

FIG. 3 is a flowchart 110 having a series of exemplary steps that are executable by the system controller 42 of FIG. 1. The steps of the flowchart 110 have particular application within the automatic tolerance determination processes of FIG. 2. To this end, the controller 42 receives sample data at block 112 of FIG. 3. As discussed herein, such sample data may include any number of product characteristics including adhesive placement, spacing and carton position.

The controller 42 may determine a statistical bell curve distribution at block 114 using the data measurement samples received at block 112. For instance, the controller 42 may use Gaussian or other normal distribution processes to determine distribution curve statistics and/or a standard deviation for each inspection point. Normal distributions include a family of bell-shaped distributions that are typically symmetric with values more concentrated in the middle than in the tails. Of such normal distributions, a Gaussian distribution is a continuous function that approximates exact binomial distribution of events. Gaussian distribution is normalized so that the sum of all values of “x” gives a probability of one for the following equation:

$${f}_{g} ( x ) = \frac{1}{\sqrt{2 {πσ}^{2}}} {θ}^{\frac{- {( x - a )}^{2}}{2 {σ}^{2}}}$$

In the above equation, “a” is the mean and “σ” is the standard deviation. “N” is the number of events and “p” is the probability of any integer value of “x.” While such a distribution equation may produce good results in certain applications, one of skill in the art will recognize that other distributions or methods may be alternatively used.

Using the determined distribution at block 116, the controller 42 may identify samples that fall outside of a distribution limit of the bell curve. Exemplary distribution limits may include ranges of outlier data that are, for instance, three standard deviations away from a mean, or that fall outside of a seventy-fifth percentile distribution, etc.

The controller 42 may discard the identified samples at block 118. That is, those samples falling outside of the limits, which may be attributable to a sampling error or other anomaly, may be ignored for purposes of future determinations. Such a future determination may include that of a new standard deviation and/or mean at blocks 120 and 122, respectively. By virtue of having discarded the outlier samples at block 118, the standard deviation determined at block 120 may have more integrity.

A respective standard deviation (or other spread) may be determined for each edge or other inspection point. This feature accommodates system irregularities such as pressure drops, jitter due to the mechanical conveyer 30, environmental electrical noise, accumulator or momentum effects, etc. While another embodiment consistent with the principles of the present invention may use an identified and apparently spurious sample when determining tolerances, elimination of such outlier samples will typically provide greater accuracy.

Similarly, the mean may be automatically determined at block 122. Where the determined mean does not match within acceptable limits a position or other measured characteristic specified by an application at block 124, that specification may be automatically adjusted at block 126 to compensate for the variation. For instance, a glue inspection point having a target position of seventy millimeters, but an actual mean of seventy-three millimeters, may cause the controller 42 to shift the target position forward three millimeters to account for the variation. Such variation may be attributable to aging equipment and/or a faulty detector, for instance. As discussed herein, correction at block 126 typically includes shifting a speed or position value to accommodate the necessary adjustment. New analysis may be conducted after the shift to account for the calibration.

The system 20 may apply a tolerance factor, “k,” at block 128 of FIG. 3. The k value may be used to specify the size of the window of the tolerance for a given inspection point. That is, the k value may indicate how many standard deviations wide a user wants to make the size of their tolerance window. For instance, a tolerance boundary may be set to a standard deviation times a plus or minus constant k. The k constant is typically set to two or three, but may range from around one to seven, though one skilled in the art will appreciate that the k constant may include a much broader range where desired. In practice, a smaller k value may result in more rejections and greater precision, while a larger k value may result in fewer rejects, but less accuracy. To this end, the k value may be set according to customer and application specifications or equipment capability.

The system 20 at block 130 may output the determined tolerance. As discussed herein, this tolerance is used for subsequent inspections to verify the accuracy of adhesive placement, for instance.

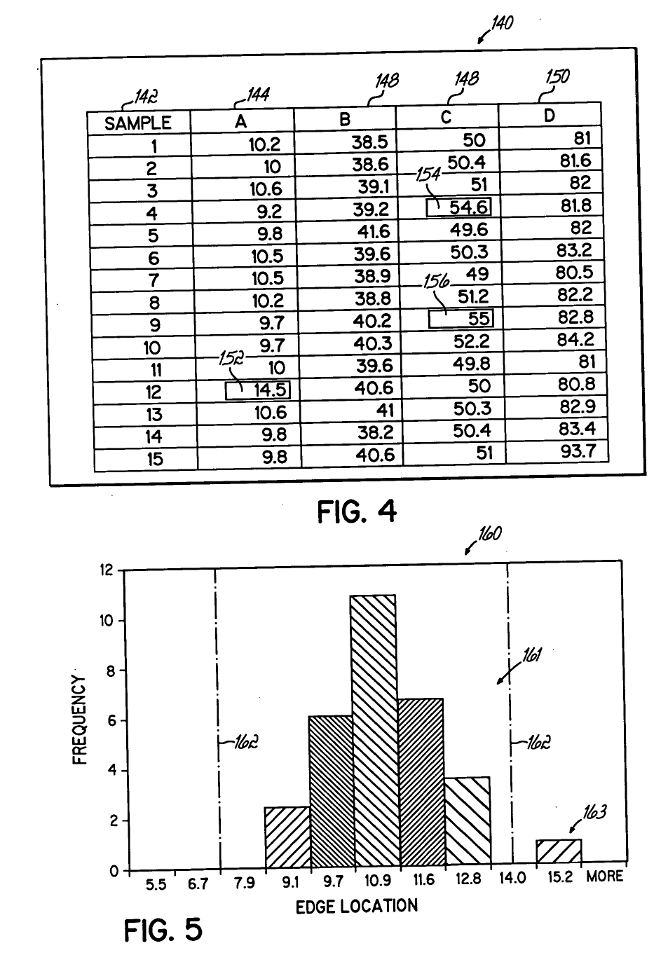

FIG. 4 shows a table 140 having exemplary sample data. More particularly, the table 140 includes data from four different inspection points, each respective point 144, 146, 148 and 150 including fifteen samples delineated in column 142. The data measurement samples pertain to inspection points that comprise different end points on an adhesive bead dispensing process. For instance, application A may relate to a leading edge 72 of a first bead. Specifications comprising a target value for the leading edge 72 call for the edge to be positioned at ten millimeters relative to a leading edge of a substrate edge surface. In the example, the user selected k factor is two and one-half standard deviations. So to determine the minimum value necessary for a sample to be within the tolerance, the system 20 subtracts 2.5 times the standard deviation from the mean. To determine the maximum value of the tolerance, the controller 42 multiplies the standard deviation by 2.5 and adds that product to the mean.

Most of the samples shown in column A 144 fall within an acceptable range of ten millimeters per a Gaussian distribution for the application. However, sample number “12” 152 includes a sample that falls outside of that accepted bell curve distribution limits. As such, this sample 152 is the type of sample that may be identified and discarded prior to determining a mean and standard deviation as discussed in the text describing FIG. 3.

Similarly, the data samples in column C 148 correspond to a leading edge 74 of a second bead. The desired placement of the leading edge is fifty millimeters. As such, samples 154 and 156 fall outside of accepted distribution limits and may be discarded to improve data integrity.

A trailing edge 72 of the first bead, the samples of which are shown in column B 146, may have a desired dispensing position of forty millimeters. All of the samples of column B fall within predetermined distribution limits, and consequently, none of the samples may be discarded in determining a mean, median, mode and/or standard deviation.

Column D 150 of the table 140 corresponds to a trailing edge 72 of the second bead. All of the samples of the column 150 fall within the Gaussian distribution limits determined by the controller 42. However, the mean of that Gaussian distribution is approximately eighty-two millimeters. This number is about two millimeters off of a desired target placement of eighty millimeters. As such, the controller 42 may automatically or in response to operator input initiate shifting the results by about two millimeters to achieve a new mean of eighty millimeters.

More particularly, the controller 42 may automatically change a target value associated with a desired pattern. The digitally stored target value may be retrieved and executed by the controller 42 to instruct the system 20 to attempt to apply adhesive at a desired position indicated by the value. To this end, the target value may include a set of coordinates, a distance value, or a timing sequence. In the above example, the target value executed by the controller 42 is around eighty millimeters. However, system variance has caused the mean value of the actual samples to deviate from the desired position by about two millimeters. The controller 42 may consequently change the target value to seventy-eight millimeters. In so doing, the controller 42 automatically adjusts the target value to compensate for whatever variation has caused the mean position to deviate from the desired position. Consequently, a new mean determined at the inspection point for a next sampling of substrate should more accurately coincide with the desired position. One skilled in the art will appreciate that the output of a controller of an alternative embodiment may also be used to guide user intervention, such as an operator's inputting instructions to adjust the target value.

FIG. 5 shows an exemplary image display 160 that shows a graph that includes a histogram 161. Such a display may appear on a monitor or other display mechanism in communication with the controller 42. Another suitable display may include a remote display at which an electronically transferable file containing the image display data arrives. In any case, edge locations comprising actual data measurements are plotted along the x-axis of the graph, and the frequency of samples is shown on the y-axis. Vertical lines 162 show in spatial terms the boundaries of the tolerance window for the inspection point. A portion 163 of the histogram that falls outside of the vertical lines 162 corresponds to potentially unacceptable adhesive placement. In any case, the portion 163 is shown along with the rest of the histogram 161 for the ready consideration of the operator.

While the present invention has been illustrated by a description of various embodiments and while these embodiments have been described in considerable detail, it is not intended to restrict or in any way limit the scope of the appended claims to such detail. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit or scope of the general inventive concept.

1. A method for operating a fluid dispensing gun configured to dispense a pattern of fluid onto a substrate moving with respect to the dispensing gun, the method comprising:
sampling a data measurement associated with an inspection point on a surface of the substrate; and
automatically determining a tolerance that includes a range of acceptable data measurements using the data measurement.

2. The method of claim 1, further comprising determining if a subsequent data measurement is within the automatically determined tolerance.

3. The method of claim 2, wherein determining if a subsequent data measurement is within the automatically determined tolerance further includes rejecting a product having the subsequent data measurement if the data measurement falls outside of the tolerance.

4. The method of claim 1, wherein automatically determining the tolerance further includes determining a spread.

5. The method of claim 4, wherein automatically determining the spread further includes determining a standard deviation.

6. The method of claim 1, wherein automatically determining the tolerance further includes determining a reference location.

7. The method of claim 6, wherein automatically determining the reference location further includes determining a mean.

8. The method of claim 6, further comprising comparing the reference location to a target characteristic.

9. The method of claim 6, further comprising adjusting a value of the target characteristic if a difference between the reference location and the target characteristic falls outside of a distribution limit.

10. The method of claim 1, further comprising displaying statistical information selected from at least one of the data measurement and the tolerance.

11. The method of claim 10, wherein the statistical information is displayed using a format selected from a group consisting of at least one of: a chart, a graph, a table, an image indicative of the data measurement relative to another data measurement, an image indicative of the data measurement relative to the tolerance, and an image indicative of the data measurement relative to the substrate surface.

12. The method of claim 1, wherein automatically determining the tolerance further includes creating statistical information.

13. The method of claim 12, wherein creating the statistical information includes creating at least one of a Gaussian curve, a spread and a normal distribution curve.

14. The method of claim 1, wherein automatically determining the tolerance further includes using a second data measurement associated with another inspection point on another substrate surface.

15. The method of claim 1, wherein automatically determining the tolerance further includes setting a tolerance factor configured to adjust the range of the tolerance.

16. The method of claim 1, wherein automatically determining the tolerance further includes determining if the data measurement is spurious.

17. The method of claim 16, wherein determining if the data measurement is spurious further includes determining if the data measurement falls within distribution limits, wherein the distribution limits are centered around a determined reference location.

18. The method of claim 16, further comprising discarding the data measurement if the data measurement is determined to be spurious.

19. The method of claim 1, wherein sampling the data measurement further includes sampling a product characteristic selected from a group consisting of at least one of: an adhesive pattern edge, an adhesive pattern length, an adhesive pattern width, an adhesive pattern height, an adhesive pattern volume, an adhesive pattern configuration and a substrate surface feature.

20. An apparatus for performing the method of claim 1.

21. An apparatus for dispensing a fluid onto a substrate comprising:
a sensor disposed adjacent a substrate, the sensor configured to generate a signal indicative of a data measurement associated with an inspection point on a surface of the substrate; and
a controller responsive to the signal configured to determine a tolerance that includes a range of acceptable data measurements.

22. The apparatus of claim 21, wherein the controller is adapted to initiate determination if a subsequent data measurement is within the automatically determined tolerance.

23. The apparatus of claim 22, wherein the controller initiates rejecting a product having the subsequent data measurement if the data measurement falls outside of the tolerance.

24. The apparatus of claim 21, wherein the controller initiates determining a spread.

25. The apparatus of claim 21, wherein the controller initiates determining a standard deviation.

26. The apparatus of claim 21, wherein the controller initiates determining a reference location.

27. The apparatus of claim 26, wherein the controller initiates determining a mean.

28. The apparatus of claim 26, wherein the controller initiates comparing the reference location to a target characteristic.

29. The apparatus of claim 26, wherein the controller initiates adjusting a value of the target characteristic if a difference between the reference location and the target characteristic falls outside of a distribution limit.

30. The apparatus of claim 21, further including a display configured to present statistical information selected from at least one of the data measurement and the tolerance.

31. The apparatus of claim 30, wherein the statistical information is displayed using a format selected from a group consisting of at least one of: a chart, a graph, a table, an image indicative of the data measurement relative to another data measurement, an image indicative of the data measurement relative to the tolerance and an image indicative of the data measurement relative to the substrate surface.

32. The apparatus of claim 21, wherein the controller initiates creating statistical information.

33. The apparatus of claim 32, wherein the statistical information includes at least one of a spread, a Gaussian curve and a normal distribution curve.

34. The apparatus of claim 21, wherein the controller initiates using a second data measurement associated with another inspection point on another substrate surface to determine the tolerance.

35. The apparatus of claim 21, wherein the controller initiates discarding the data measurement if the data measurement is determined to be outlier.

36. The apparatus of claim 21, wherein the data measurement is selected from a group of product characteristics consisting of at least one of: an adhesive pattern edge, an adhesive pattern length, an adhesive pattern width, an adhesive pattern height, an adhesive pattern volume, an adhesive pattern configuration and a substrate surface feature.

37. A program product, comprising:
program code in communication with controller for operating a fluid dispensing gun dispensing a pattern of fluid onto a substrate moving with respect to the dispensing gun a server computer, the program code configured to automatically determine a tolerance that includes a range of acceptable data measurements using a signal received by the controller from a sensor and indicative of a data measurement associated with an inspection point on a surface of the substrate; and
a signal bearing medium bearing the program code.

38. The program product of claim 37, wherein the signal bearing medium includes at least one of a recordable medium and a transmission-type medium.
